(19) United States
(12) Patent Application Publication
(10) Pub. No.: US 2004/0163075 A1
(43) Pub. Date: Aug. 19, 2004

(54) Method for the automatically implanting software functions on a set of processors

(76) Inventor: Bert Beltmann, Borculo (NL)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/312,178

(22) PCT Filed: Jun. 26, 2001
(86) PCT No.: PCT/FR01/02019

(30) Foreign Application Priority Data
Jun. 30, 2000 (NL) 1015579

(51) Int. Cl. G06F 9/44

(52) U.S. Cl. 717/120

(57) ABSTRACT

The present invention relates to a method for the automatic assignment of software functions among a set of processors.

The method comprises at least:

a step of breaking down software functions into elementary tasks (SW₁, . . . SWₖ, . . . SW_{N});

a step of assignment of the elementary tasks among the processors (HW₁, HW₂, HW₃, HW₄);

a step of checking assessment parameters of the assignment, a list of which is pre-established, a penalty being allocated to the assignment when a parameter does not meet a given criterion;

a step of calculation of the cost of the assignment, this cost being the sum of the allocated penalties, the chosen assignment depending on this cost.

The invention applies in particular to systems, such as radar systems for example, comprising a large quantity of software functions.

The present invention relates to a method for the automatic assignment of software functions among a set of processors. It applies in particular to systems, such as radar systems for example, comprising a large quantity of software functions.

The quantity of software functions used, in particular in radar systems, is increasing rapidly. Similarly, the quantity of processors used is increasing. These processors are for example of the signal processing type. A given application can necessitate up to several tens of processors. The work of assigning the software among the available processors is becoming increasingly long and difficult. Furthermore, if software functions are added subsequently, which is frequently the case, it is impossible to redistribute the software among the set of processors without major modification of the software or hardware architecture.

It therefore appears that, in such systems, the assignment of software functions among the set of processors is a crucial problem. There is certainly a problem of time and of complexity of installation of the software functions but there is also a problem of flexibility. In fact it is necessary to be able to integrate new software functions easily. These problems give rise to excess costs of production of systems. Furthermore, they have an effect in particular on the maintenance, testing and reliability of these systems.

A purpose of the invention is, in particular, to allow an automatic and optimal assignment of the software among the processors, that is to say simple and economic. For this purpose, the invention relates to a method for the assignment of software functions among a set of processors, comprising at least:

a step of breaking down software functions into elementary tasks and of creating files defining the links between the tasks and the connections of the processors;

a step of assignment of the elementary tasks among the processors according to the preceding files;

a step of checking assessment parameters of the assignment, a list of which is pre-established, a penalty being allocated to the assignment when a parameter does not meet a given criterion;

a step of calculation of the cost of the assignment, this cost being the sum of the allocated penalties, the chosen assignment depending on this cost.

The chosen assignment preferably corresponds to the minimum cost. The steps of assignment of the tasks, of checking the assessment parameters and of calculation of cost are repeated, an installation then being chosen when the variation in cost converges within a given threshold, of the order of 2% to 3% for example. The assessment parameters relate in particular to the data flow, to the load on the processors and to the processing time of the tasks.

The main advantages of the invention are that it allows a great flexibility of assignment of the various tasks of a system, that it increases the reliability of the system, that it facilitates the maintenance of the system and that it facilitates the subcontracting of subassemblies.

Other characteristics and advantages of the invention will become apparent with the help of the following description referring to appended drawings in which:

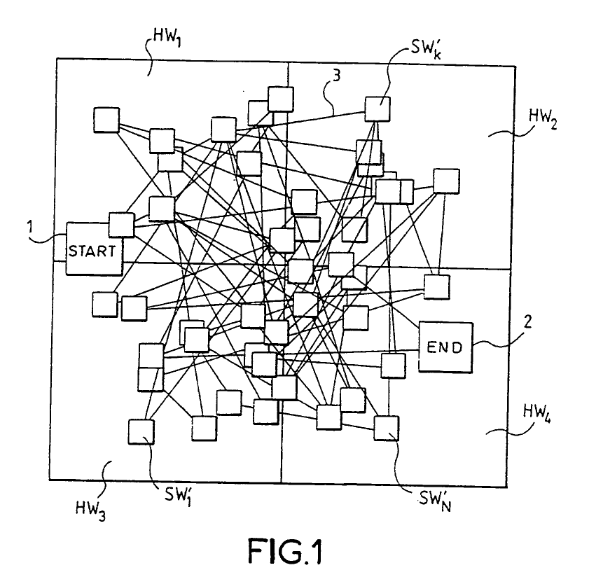

FIG. 1 shows an example of allocation of software functions to a set of processors;

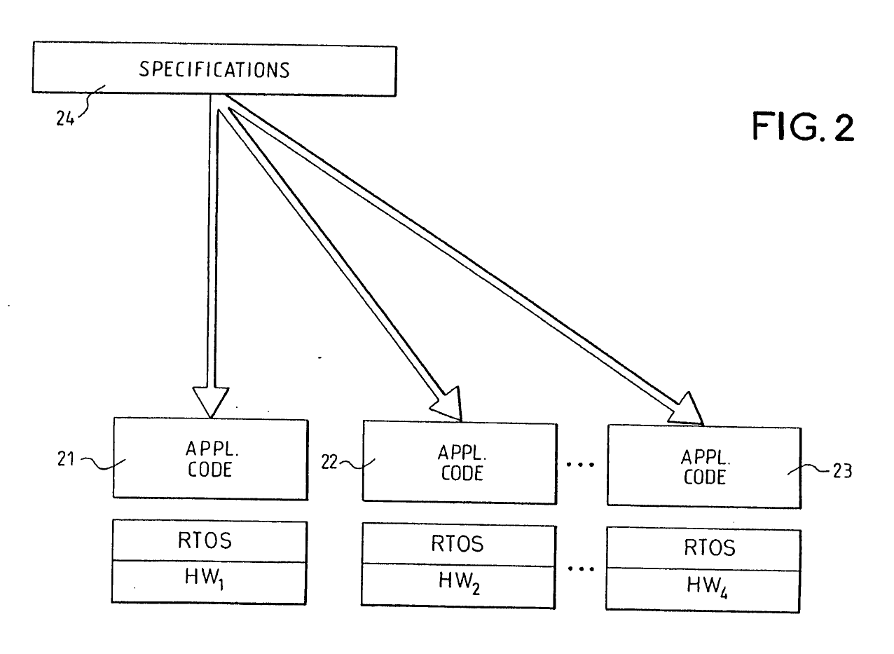

FIG. 2 shows a block diagram of a software architecture corresponding to the preceding allocation;

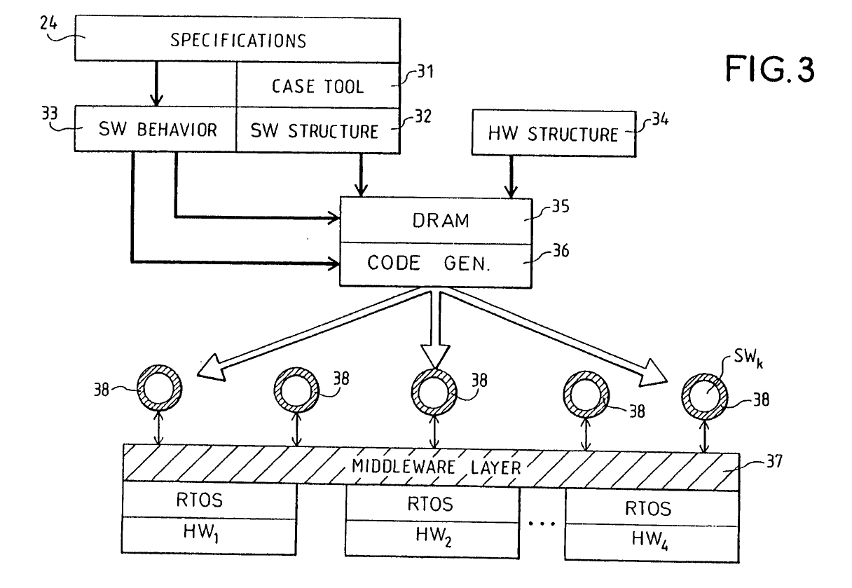

FIG. 3 shows a block diagram of a software architecture obtained on applying the method according to the invention;

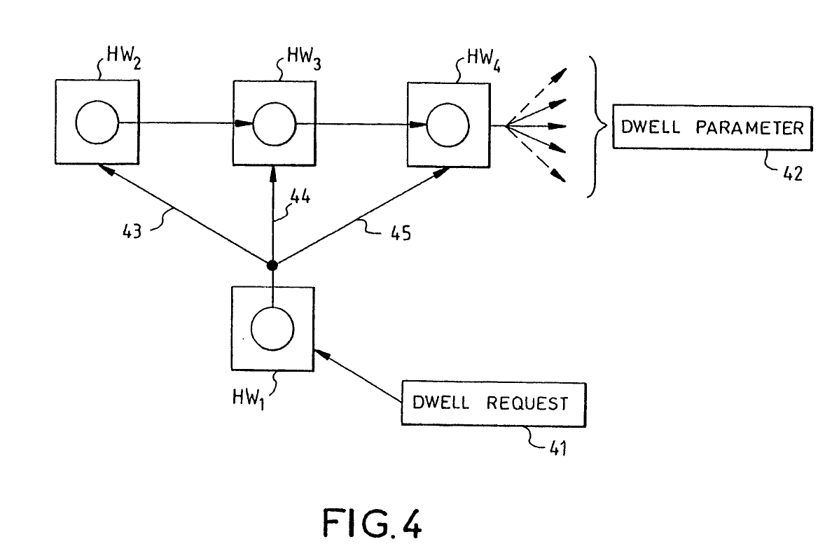

FIG. 4 shows an example of a means of checking parameters relating to the data flow between the processors;

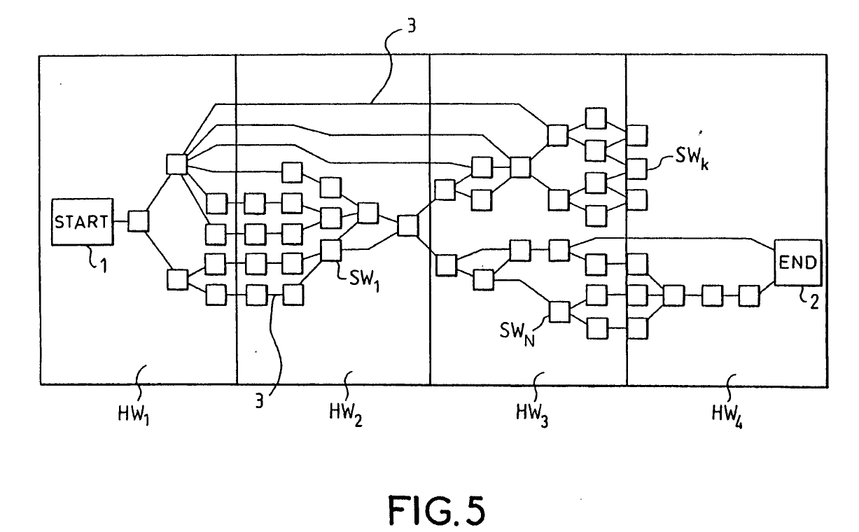

FIG. 5 shows an example of assignment of software functions obtained on applying the method according to the invention.

FIG. 1 shows an example of allocation (mapping) of N software functions SW′₁, . . . SW′ₖ, . . . SW′_{N} among a set of processors HW₁, HW₂, HW₃, HW₄. By way of example, the number of processors is four. Certain applications can however necessitate several tens of processors. The software functions group the tasks of a complete program, for example a radar simulation or processing program. This program goes from a start task 1 up to an end task 2. The overall program can for example comprise several hundred tasks representing in total several tens of thousands of code lines. A processor executes one task SW′ₖ at a time. The lines 3 of FIG. 1 connecting the software components between each other illustrate the running or interfacing of the tasks. A line 3 which connects two software components indicates that the two tasks that they execute can follow one another. That is to say that a task is executed when the preceding one is completed.

The processors HW₁, HW₂, HW₃, HW₄ comprise in particular, in addition to the actual processing circuits, the program memories and the interface circuits with the other hardware components. A processor HWₖ can for example occupy a card.

FIG. 1, which furthermore illustrates the data flow between the start task 1 and the end task 2, shows that the allocation of the software components is not optimal. A first disadvantage is that the allocation of tasks SW′ₖ is not compatible with their interfacing. By way of example, two tasks separated from each other in the overall running of the tasks are executed by a same processor. Given that a processor can execute only one task at a time, the overall processing time between the start task 1 and the end task 2 is not optimized. In fact, the goings and comings between one processor and another in the running of tasks lengthens the processing time. Another disadvantage is that the system is not very flexible or is even inflexible. A change of algorithm can result in a new and complete distribution of the software, or even a modification of the hardware architecture.

FIG. 1 in fact shows the running of the execution of the various tasks of a program by four processors without a pre-established rule. The program parts are assigned essentially according to the availabilities of the processors. The elementary tasks in fact exist, but the program is not broken down into elementary tasks in such a way as to distribute the latter among the processors. Certain tasks can even straddle two processors. This allocation is complex to implement and, as mentioned previously, it lacks flexibility.

FIG. 2 shows a software architecture corresponding to the allocation of the software components according to FIG. 1. For each processor, HW₁, HW₂, . . . HW₄, the associated software layers are shown. A Real Time Operating System (RTOS) is installed on each processor. This operating system conventionally allows the execution of the program code 21, 22, 23. The latter results from specifications 24. The software layer defined by the codes of the application 21, 22, 23 comprises all of the previously mentioned tasks SW′₁, . . . SW′ₖ, . . . SW′_{N}.

FIG. 3 shows in the form of a block diagram a software functions architecture obtained by applying the method according to the invention. In a first step, the method according to the invention therefore breaks down the program into elementary tasks. These tasks are programmed by groups of codes forming software components. For simplification, an elementary task can be assimilated hereafter by its corresponding software component. This breakdown is for example carried out by a software engineering system 31, also called CASE, an acronym for the English expression “Computer-Assisted Software Engineering”. This CASE tool will also define the structure of the software, that is to say it will define the link [sic] between the different elementary tasks or the way in which the latter depend upon one another. The breakdown is preferably such that the elementary tasks correspond to the smallest possible software components, that is to say having a minimum number of lines of code, for example of the order of 100 to 200. The CASE tool, in particular, produces this structure in accordance with the start specifications 21. This tool defines, for example, a list of elementary tasks furthermore describing the way in which the latter are interconnected. This software structure information and this list of tasks are stored in a file 32. The specifications furthermore define the software function or functions stored in a file 33. Furthermore, a list of the available processors describing the way in which the latter are interconnected can be established. This list defines the hardware structure supporting the whole of the program formed by the elementary tasks. It can be stored in a file 34. These files 32, 33, 34 form a description of the system, used thereafter for the assignment of the elementary tasks.

Once the software structure has been defined, its software components are assigned to the different processors. This assigning is for example carried out by a second software tool 35, hereafter called the DRAM tool, derived from the English expression “Dependency Related Allocation and Mapping”. This tool carries out a first allocation of the software components according to the preceding files 32, 33, 34. This allocation is for example carried out in a random manner. The DRAM tool then carries out a series of assignment assessment parameter checks, based on given criteria. These criteria are for example related to the data flow, to the load on the processors, to the processing time or even to design constraints. When a checked parameter does not meet a given criterion, a penalty is allocated to the assignment. When all of the parameters, the list of which is pre-established, have been checked, the DRAM tool calculates a cost which is the sum of the penalties. The optimal assignment is that which has the minimum cost. In practice, the chosen assignment can have a cost that is different from the minimum cost. In any case, it depends on the cost, a solution having a cost that is too high being discarded.

The following text describes a possible example of the use of the parameters check characterizing the allocation of the software components and of the associated penalties. In this example, it is considered that the system comprises four cards HW₁, HW₂, HW₃, HW₄, each card being able to contain one or more processors.

FIG. 4 shows a means of checking parameters relating to the data flow. In order to check the data flow, a pipeline processing is carried out starting from the incoming requests on the first card HW₁. More precisely, a request 41 of the “trigger” type is sent to the input of this first card. This request results in the activation of parameters 42 on the output of the fourth card HW₄. This furthermore implies that the parameters processed by the first card HW₁, activated as a result of the request 41, are processed by all the other cards HW₂, HW₃, HW₄ during all of the processing. In order to minimize unnecessary data transfers, the data must be processed just in time before being used. Given that it is probable that all of the processed data, principally the data resulting directly from the request 41, is necessary for the other cards HW₂, HW₃, HW₄, the first card HW1 comprises communication links 43, 44, 45 with the other processors. For each elementary task SWₖ, the DRAM tool tracks the elementary task or tasks producing the data consumed by this elementary task SWₖ. The elementary task or tasks producing this data can be processed by the same card or by another card, and within a same card by the same or by another processor.

A first parameter characterizing the data flow can be the “forward” inter-processor communication. In this case, the input data of an elementary task in question is processed by the card physically just in front of the card processing this task. For example, an elementary task of the third card HW₃ necessitates a parameter produced by the second card HW₂. In order to minimize the data transfers, all of the input parameters are preferably processed by the same processor, or at least by the same card. The penalty given for a forward inter-card communication would be higher than an inter-processor communication. There is an even greater penalty if the data passes through two or more cards. Thus the DRAM tool can for example multiply the penalty given for a forward inter-card communication by the number of cards passed through between the production of the parameters and their utilization. By way of example, a penalty for a forward inter-card communication can be equal to 4.

A second criterion relating to the data flow can be the backward inter-card communication. The input parameter is processed by another card. This card is physically behind the current card, that is to say the data has not yet been processed. For example, an elementary task of the second card HW₂ necessitates a parameter produced by an elementary task carried out by the card HW₃. In order to minimize the transfer of data from one card to another, the data must flow in a single direction, from the first card HW₁, to the last card HW₄. If it is considered that it is important to avoid backward inter-card communications, a heavy penalty can be allocated to such a communication. This penalty can for example be equal to 1000.

Another type of criterion to take into account is the processing load on the processors. The DRAM tool takes account of the loads on the processors in order, in particular, not to place too many tasks in a same processor. For each elementary task, the processor load necessitated is defined in an input file, which is for example the same file as the one containing the list of those tasks. By way of example, the load on the processor for the execution of an elementary task can be defined for the maximum theoretical utilization, the maximum practical utilization or the mean utilization of that task. In this way, the load on the processor is used as a direct method to ensure a correct allocation of tasks among the processors.

A first case to be taken into account is that where the execution of a task results in the exceeding of a threshold, for example 95% of the maximum load authorized for the processor. The DRAM tool must not authorize this case. The penalty for exceeding this 95% can therefore be equal to 10,000. It is furthermore possible to envisage several levels of overload, with decreasing penalties, below the absolute maximum of 95%. A penalty can for example also be allocated if a processor is insufficiently loaded. This in particular incites a maximum use of the available processors, within the limit of course of the permissible overloads.

Another important criterion to take into account is the processing time of the data. The processing time can be considered in at least two ways. A first processing time to be checked can be the time necessary for executing all of the tasks allocated to a processor with their frequencies of execution. This frequency of execution is defined for each task, the information being stored for example in the description file of the tasks. The DRAM tool must for example check that this total execution time of the tasks on a same processor does not exceed a given duration. This check may be necessary, since there is no obligatory relationship between the load on the processor and this execution time. By way of example, when this execution time for a processor exceeds a given value, the penalty allocated can be equal to 10,000. It is possible to allocate decreasing penalties in accordance with decreasing execution time thresholds.

A second execution time to be taken into account is the execution time of the complete program. All of the program execution branches are processed by the DRAM tool on each card. The branch having the longest cumulative program execution time determines the processing time relating to the card. The processing time of the program by the complete system is the sum of the processing times of each card HW₁, HW₂, HW₃, HW₄. Failure to comply with a maximum authorized processing time can be severely penalized, for example by a penalty as high as 250,000. Reducing the authorized processing time, or increasing the penalty for excess processing times, incites the DRAM tool to make the processors work in parallel.

Another series of criteria to be checked can relate to the design constraints of the system. For various reasons, the designers may wish to influence the mapping, that is to say the assignment of the elementary tasks to the processors. The method according to the invention can allow several assignment facilities. In particular, the designer can impose the placing of a task on a specific processor, this allocation being specified for example in the description file of the system. Given that the DRAM tool does not intervene in this allocation, the allocation of penalties does not arise. However, if a dangerous situation appears relating for example to the processing time or the load on the processor, the DRAM tool can send an alarm message.

It is also possible to couple several elementary tasks, that is to say to impose their allocation to a same processor or a same card, this processor or this card not being imposed. This can in particular be advantageous when the tasks share the same data pool. This coupling of tasks can be specified in the description file. Failure to comply with this constraint can be penalized by a relatively heavy penalty, for example one equal to 100. If the coupling is impossible due to violation of design rules, relating for example to the processing time or to the load on the processors, the DRAM tool sends an alarm message. All of the penalties are defined, for example, in the configuration file of the DRAM tool.

The penalties are preferably chosen with care. In particular, it is necessary to make the degree of penalty correspond with the degree of constraint attached to a design parameter. The various design rules are connected to each other; in particular they affect one another. The best design can be the best combination of these rules. Thus the best design should be the one whose cost expressed in the form of penalties is the lowest. According to the invention, a method for determining the minimum cost, or at least a cost approaching it, consists in repeating the algorithm for assigning elementary tasks. When this algorithm is repeated, the different solutions obtained have different penalties. The repeated steps are as follows:

the step of assigning the elementary tasks among the processors;

the step of checking assessment parameters of the assignment, a list of which is pre-established;

the step of calculating the cost of the assignment.

It is considered that several good solutions can be obtained. The penalty cost varies little from one to the other of these best solutions. For example, a threshold of between 2% and 3% is chosen. When the cost variation of a repeat remains within this threshold, it is considered that the solution is acceptable. In practice, a solution can therefore be chosen when the cost variation converges within the threshold, for example within 2% to 3%. During a first phase, each task is allocated to a randomly selected processor. During the other phases, between one repeat and another, only one task, chosen randomly, is reallocated to another processor, also chosen randomly. The cost is calculated for each of these repeats.

The total duration of allocation of tasks (mapping) carried out by the DRAM tool can be less than 5 minutes for one repeat. A large number of repeats can therefore be accomplished by this tool. The best assignment can therefore be obtained relatively quickly and automatically, and therefore economically. As mentioned above, the cost in penalties indicates if this final assignment is obtained. On approaching an acceptable solution, the cost should vary less and less from one repeat to another, provided however that the penalties are chosen carefully, that is to say depending on the degree of the constraint attached to a design parameter. If the costs vary greatly, this indicates that one or more allocation parameters are not at all correct. Instead of beginning with a completely random mapping, it is possible to provide a pre-selection of processors according to certain criteria, for example related to the data flow.

Once the allocation of tasks has been completed by the DRAM tool, that is to say once a solution has been determined with an acceptable cost in penalties, a code generator 36 creates a code which allows all of these elementary tasks to be executed by the various processors or cards HW₁, HW₂, . . . HW₄ involved. To an elementary task there corresponds a software component SWₖ, comprising several tens or several hundreds of lines of code. The cross-hatched parts of FIG. 3 correspond to the code generated by the code generator 36. The latter produces an intermediate layer (middleware) 37 which communicates with the operating systems (RTOS) of the processors or cards. The code generator also produces a software layer 38 around each software component, allowing it to communicate with the middleware layer 37 and therefore to be executed by the corresponding processor. The generator therefore creates a kind of “glue” code which binds the software components HWₖ to the processors. In fact it makes it possible to connect the software components with the physical locations, processors and cards indicated by the DRAM tool, in accordance with the selected assignment.

FIG. 5 illustrates a possible allocation of software components SW₁, . . . SWₖ, . . . SW_{N} among the cards HW₁, HW₂, HW₃, HW₄ obtained on applying the method according to the invention. This figure shows that the constraints related to the data flow are indeed taken into account. In particular, the software components SWₖ are better arranged among the set of cards HW₁, HW₂, HW₃, HW₄. The other constraints, in particular relating to load and execution time, are of course complied with. FIG. 5 illustrates other advantages of the invention. It shows in particular that a great ease of maintenance and increased reliability are obtained. In particular, in the event of the failure of a card, it is easy to replace it without problems relating to interfaces with the other cards. It is also easier and more economical to subcontract subassemblies of the complete system. In the example of an assignment such as shown in FIG. 5, a first subcontractor can assume responsibility for the first card, hardware and software included, a second subcontractor can assume responsibility for the second card, and so on. The cards are subsequently assembled without problems, the hardware and functional interfacing of one card with another being easy.

Finally, the invention allows a great flexibility of assignment. In fact, in the case of adding one or more tasks, it is easy to apply the method according to the invention, using the DRAM tool for example. In this case, the starting point is for example the existing configuration and the new task or tasks are allocated randomly. The repeats are then initiated. The result can in particular impose the adding of a new processor if no acceptable cost is obtained.

The invention has been explained for an example of application to four processors, but the number of processors can of course be greater.

1. Method for the assignment of software functions among a set of processors, characterized in that it comprises at least:
a step of breaking down software functions into elementary tasks (SW₁, . . . SWₖ, . . . SW_{N}), of creating a file (32) defining the link [sic] between the different elementary tasks and creating a file (34) defining the connections of the processors (HW₁, HW₂, HW₃, HW₄);
a step of assignment of the elementary tasks among the processors (HW₁, HW₂, HW₃, HW₄) according to the preceding files (32, 34);
a step of checking assessment parameters of the assignment, a list of which is pre-established, a penalty being allocated to the assignment when a parameter does not meet a given assessment criterion;
a step of calculation of the cost of the assignment, this cost being the sum of the allocated penalties, the chosen assignment depending on this cost.

2. Method according to claim 1, characterized in that the chosen assignment substantially corresponds to the minimum cost.

3. Method according to either of the preceding claims, characterized in that the steps of assignment of the tasks, of checking the assessment parameters and of calculation of cost are repeated, an installation being chosen when the variation in cost converges within a given threshold.

4. Method according to claim 3, characterized in that during the first run, each task is allocated to a processor randomly and then only one task, chosen randomly, is reallocated to another processor between one repeat and another.

5. Method according to any one of the preceding claims, characterized in that the assessment parameters relate to the data flow, to the load on the processors and to the processing time of the tasks.

6. Method according to any one of the preceding claims, characterized in that to an elementary task (SW₁, . . . SWₖ, . . . SW_{N}) there corresponds a software component, a code generator (36) creates an intermediate layer (middleware) (37) which communicates with the operating systems (RTOS) of the processors, the code generator also producing a software layer (38) around each software component, allowing it to communicate with the intermediate layer (37) and therefore to be executed by the corresponding processor, in accordance with the chosen assignment.
